(19) United States
(12) Patent Application Publication
(10) Pub. No.: US 2019/0125130 A1
(43) Pub. Date: May 2, 2019

(54) LOW PROFILE FRYER

(71) Applicant: ILLINOIS TOOL WORKS INC., Glenview, IL (US)

(72) Inventor: Kacy W. Denning, Charlotte, NC (US)

(21) Appl. No.: 16/175,118

(22) Filed: Oct. 30, 2018

Related U.S. Application Data
(60) Provisional application No. 62/579,418, filed on Oct. 31, 2017.

(51) Int. Cl. A47J 37/12

(52) U.S. Cl. CPC A47J 37/1209; A47J 37/1295; A47J 37/129; A47J 37/1266

(57) ABSTRACT

A fryer unit includes a housing, and a fryer vat supported by the housing and defining a volume for receiving oil to be heated for cooking. An oil heating system includes at least one immersed electrical heating unit within the fryer vat for heating oil within the fryer vat. An overall height of the fryer unit is no more than twenty-five inches so as to be adapted for positioning upon an appliance base or countertop.

### CROSS-REFERENCES

This application claims the benefit of U.S. provisional application Ser. No. 62/579,418, filed Oct. 31, 2017, which is incorporated herein by reference in its entirety.

### TECHNICAL FIELD

The present application relates generally to deep-fat fryers and, more particularly, to a deep-fat fryer with a low profile adapted for use atop countertops or other appliances of similar height to countertops.

### BACKGROUND

A typical deep-fat fryer will include a fryer vat containing a heated bath of cooking oil. The fryer vat is supported on a frame/housing that sits directly on the floor. Such fryers are often referred to as freestanding fryers. Space is a premium in commercial cooking environments.

It would be desirable to provide a low profile fryer, capable of positioning atop another appliance or a countertop, that performs adequately for the commercial cooking environment.

### SUMMARY

In one aspect, a low profile countertop fryer unit includes high throughput and temperature recovery. Appropriate sizing of the fryer unit chassis/housing relative to the vat achieves temperature mitigation. Insulation may also be included to improve reliability.

In another aspect, a fryer unit includes a housing, and a fryer vat supported by the housing and defining a volume for receiving oil to be heated for cooking. An oil heating system includes at least one immersed electrical heating unit within the fryer vat for heating oil within the fryer vat. An overall height of the fryer unit is no more than twenty-five inches so as to be adapted for positioning upon an appliance base or countertop.

In a further aspect, a fryer unit includes a housing, and a fryer vat supported by the housing and defining a volume for receiving oil to be heated for cooking. An oil heating system includes at least one immersed electrical heating unit within the fryer vat for heating oil within the fryer vat. A working height of the fryer unit is no more than sixteen inches. The housing also includes a condiment rack at a front side of the fryer unit.

### BRIEF DESCRIPTION OF THE DRAWINGS

FIG. 1 is a perspective view of a fryer;

FIG. 2 is a side elevation of the fryer;

FIG. 3 is another perspective view of the fryer;

FIG. 4 is another perspective view of the fryer;

FIG. 5 is a partial exploded perspective of the fryer;

FIG. 5A is a partial perspective of a wire cover of the fryer;

FIGS. 6 and 7 are perspective views of a control interface of the fryer;

FIGS. 8-10 show perspective views of a quick-disconnect arrangement of the fryer;

FIG. 11 is a perspective view of a drain pipe of the fryer;

FIG. 12 is a perspective view of another embodiment of a fryer; and

FIG. 13 is a side elevation of the fryer of FIG. 12.

### DETAILED DESCRIPTION

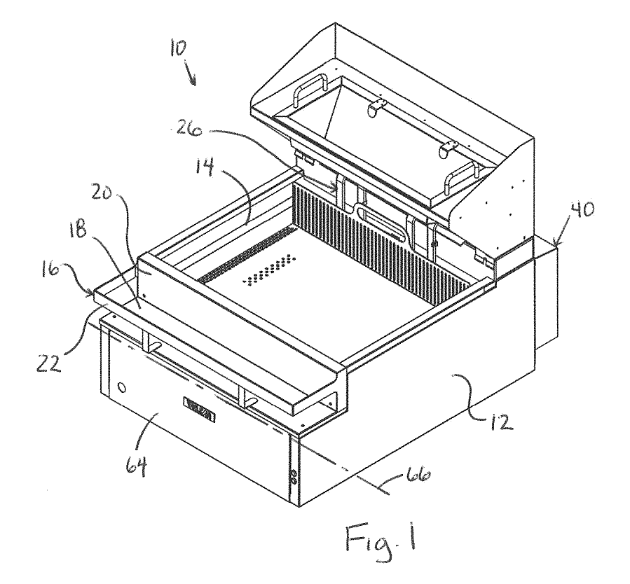

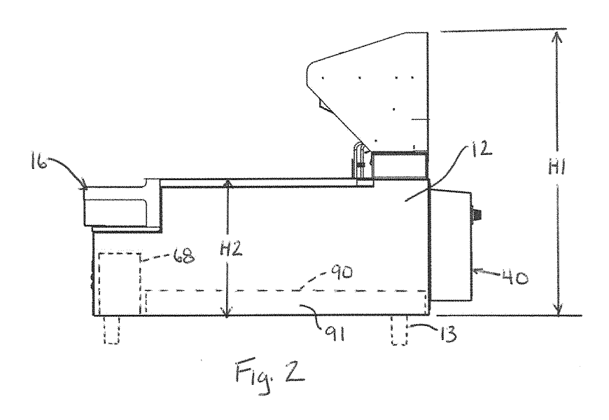

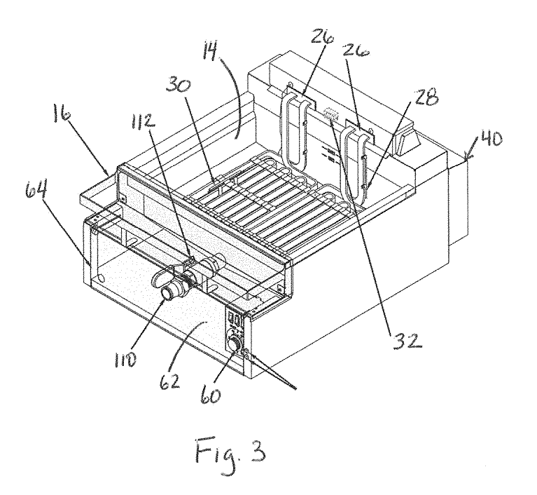

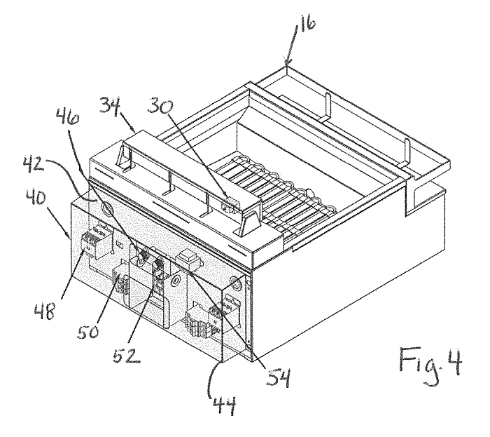

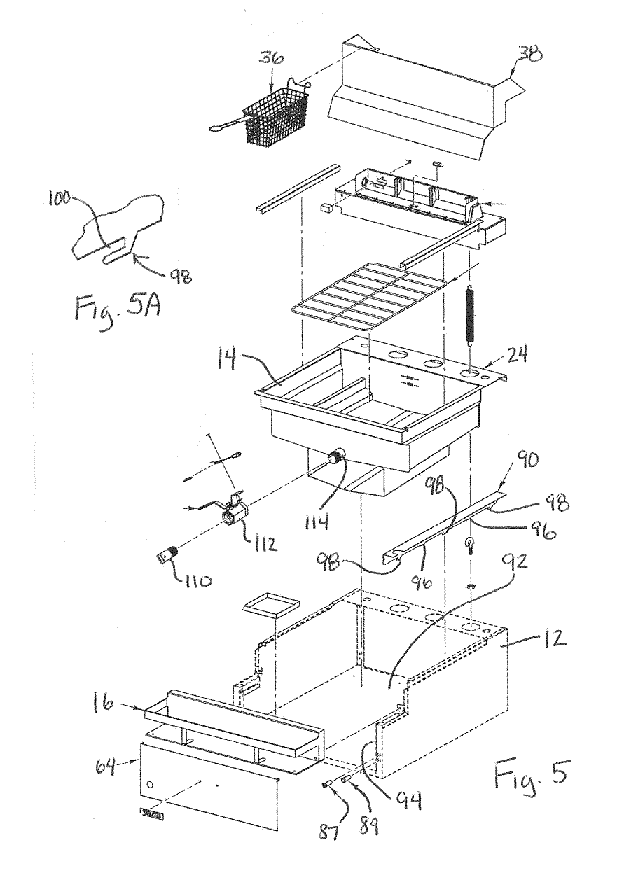

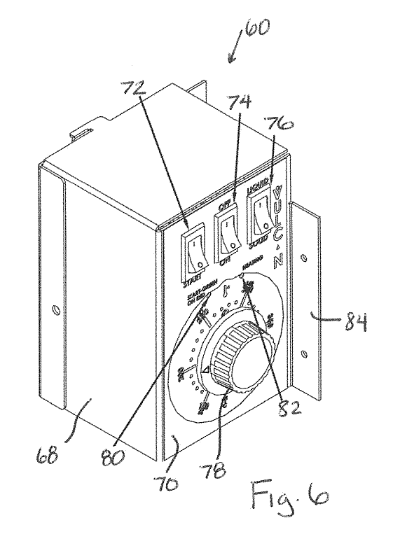

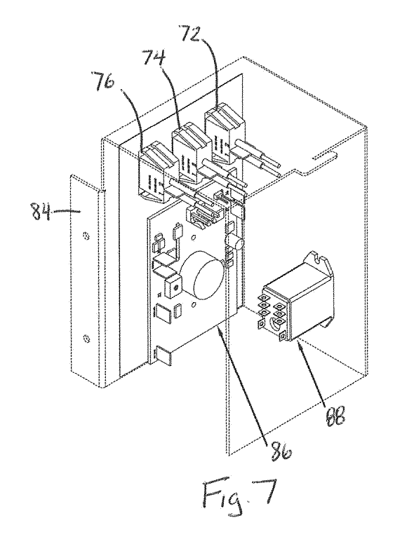

Referring to FIGS. 1-7, a fryer 10 includes a housing 12 that supports an open-top vat 14 having front, rear, left, right and bottom side wall portions. In some implementations, legs 13 may support the housing 12. The housing 12 incorporates a rack 16 at the front end of the fryer, which can be used to hold food product that will be incorporated into items to be fried. For example, the rack 16 may hold tubs or pans of batter or dry coatings (e.g., spiced flour or bread crumb mixes) into which fish, chicken or other food items to be fried can be dipped. The rack can also be used to hold condiments to be applied to the food items after frying (e.g., sauce mixes for wings). The rack 16 is open at the top and is formed by a bottom wall 18, a rear wall 20 and rail 22 that extends along the sides and front of the rack. The condiment rack 16 may be removable from the rest of the housing as a single piece.

The vat 14 walls may, for example, be formed of stainless steel or aluminum sheet metal that is formed and welded. A panel 24 extends rearward from the top of the fryer vat 14 and includes openings to facilitate connections to the electrical heating elements 26 (e.g., resistance heaters) that extend down into the vat for heating oil within the vat, as well as other components, and to provide a path for springs that facilitate upward tilt of the heating elements. The elements 26 may be ribbon style heating elements that create desirable surface area for quick recovery and shorter cooking times. A temperature sensor 28 also extends down into the vat to facilitate control of the heating elements to achieve and maintain a desired oil temperature. A high limit switch assembly 30 may also be provided and includes a portion within the vat to facilitate de-energization of the heating elements if an excessively high temperature is detected. A tilt switch 32 enables pivoting movement of the elements 26 to a position raised up out of the vat to facilitate vat cleaning. A cover 34 is provided to cover the heads of the heating elements 26. Cooking baskets 36 are typically used to submerge food items in oil within the vat, and the baskets may be hung from a rear hanger wall 38 that is raised above the vat.

In one implementation, the fryer 10 is sized with a total footprint of no more than 40 inches deep by 30 inches wide (e.g., footprint of 1200 square inches or less), and a total height H1 of less than 23 inches (not including legs 13 at the underside of the unit), and with a fryer vat capacity of between 70 and 80 pounds of oil (e.g., between 73 and 77 pounds, or about 75 pounds). The typical leg height at the underside of the unit housing (if legs are included) would be no more than about six inches (e.g., nor more than about five inches, or about four inches or less). The working height H2 of fryer may be no more than about sixteen inches (e.g., no more than about fourteen inches), where the working height is defined by the depth or height of the housing surrounding the fryer vat (not including any raised sections or portions at the back of the unit and not including any legs at the underside of the unit).

Considering the productivity of a fryer involves evaluation of throughput and recovery. Throughput may be rated in pounds of product per hour the unit can cook, and temperature recovery may be defined based upon the removal of cooked food product from the vat and the fryer's ability to recover back to a cooking temperature set point. Notwithstanding the relatively small size of the fryer 10, high throughput is still achieved. For example, achieved throughput of 85 lbs/hr or more of French Fries per ASTM Test Method F1361-07 with an associated efficiency of 80% or more, and 45 lbs/hr or more of Bone-In Chicken per ASTM Test Method F1964-11 with an associated efficiency of 70% or higher, is provided.

One key to achieving such throughputs in the relatively small size of the fryer 10 is the incorporation of an electrical cabinet 40 at the rear side of the fryer vat. The electrical cabinet 40 includes a rear wall 42 and a cover 44 secured to the rear wall (e.g., by screws). The rear wall 42, which may be thermally insulated, separates the fryer vat from the cabinet volume. The electrical cabinet houses, for example, fuses 46, contactors 48, circuit breakers 50, a terminal block 52 and a transformer 54. The control interface 60 is located in a space 62 at the front of the fryer, below the rack 16 and behind an access door 64. The access door 64 is mounted to enable it to pivot upward about a horizontal axis 66 and then slides inward below the bottom wall 18 of the rack 16. The control interface 60 includes a box-shaped housing 68 with a front wall 70 that presents the front portions of switches 72, 74, 76, a temperature control knob 78, an ON LED indicator 80 and a heating LED indicator 82. Switches 72-76 may, for example, be rocker switches, with one switch operating as a START switch, one switch operating as a ON/OFF switch and one switch operating as a MELT switch. A mount flange 84 is provided to secure the control interface 60 to the housing 12. A control board 86 and relay 88 may be provided within the housing 68. LED indicators 87 and 89 may also be provided on the front of the housing.

The relay 88 and control board 86 are electrically connected with the components in the electrical cabinet 40 via wiring that passes within the housing 12 and below the fryer vat 14. To facilitate the wiring connection while at the same time shielding the wiring from the heat of the fryer vat, a raceway 91 is formed within the housing. In particular, an L shaped wire cover 90 is mountable within the housing compartment against the internal bottom wall 92 and internal side wall 94 of the housing such that the wire cover 90, along with a portion of the bottom wall 92 and a portion 94 of the sidewall, forms a rectangular raceway from the front of the fryer (e.g., proximate the control interface 60) to the back of the fryer (e.g., proximate the cabinet 40). The wire cover 90 includes a set of downwardly extending tangs 96 and 98 that align with slots in the bottom wall 92 to position the wire cover. Here, the tangs 98 form slots 100 that will slidingly engage with the edge of the slots in the bottom wall 92 to removably retain the wire cover 90 in place. Preferably, an internal section of the housing 12, running from the front of the fryer vat to the rear of the fryer vat, does not include any electrical components that could be damaged by heat from the fryer vat.

An advantageous quick-disconnect system is also provided for draining the fryer vat. In particular, a male quick disconnect fitting 110 is installed on the outlet side of the ball valve 112 enables draining of the fryer vat 14 (e.g., where the ball valve 112 is threaded onto a pipe stud 114 at the front of the fryer vat 14, and the male quick disconnect fitting 110 is threaded to the ball valve 112).

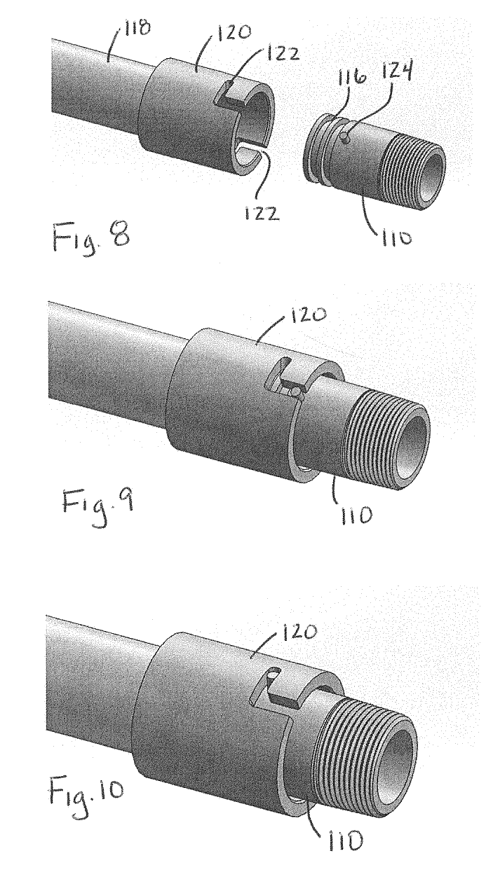

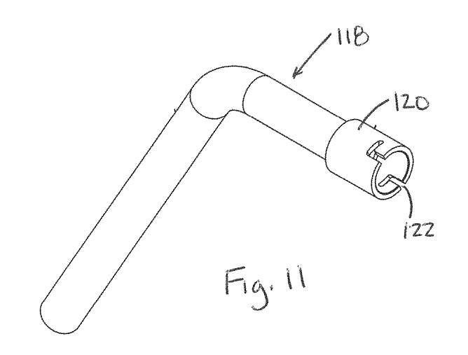

As seen in FIGS. 8-10, the fitting 110 may include two o-rings (not shown) are seated in annular seats 116 of the fitting 110 (e.g., in machined grooves). For attachment, the drain pipe 118 includes a welded on female quick disconnect fitting 120 with an L-shaped connection slots 122. The fitting 120 approaches the end of fitting 110, slips on, with fitting slots 122 in alignment with retention pins 124 on fitting 110, and is rotated (e.g., twenty or thirty degrees) to lock the drain pipe 118 in place. Disconnection is a reverse operation. The drain pipe 118 may include two segments that angularly meet per FIG. 11. This arrangement provides a large drain valve and quick-disconnect to accelerate oil filtration and extend oil life for greater savings.

In one implementation, the low profile fryer 10 includes a resistive type electrical heating system that is powered by 3-phase voltage of 200 volts or more (e.g., 208/3 Phase, 240/3 Phase or 480/3 Phase). The total power of the heating system may be between 23 and 28 kW (e.g., between 23 kW and 25 kW, or about 24 kW) and two heating elements 26 are used, each having three resistance wire elements therein, where the resistive wire elements are tuned to the known power source that will be used. By example, the amps per resistive wire element and ohms per resistive wire element may be in accordance with the following table:

TABLE 1
Exemplary Power Ratings

| | | AMPS PER | OHMS PER |
|---|---|---|---|
| VOLTAGE | TOTAL KW | ELEMENT | ELEMENT |
| 208/3 Phase | 24 | 19.2 | 10.8 |
| 240/3 Phase | 24 | 16.7 | 14.4 |
| 480/3 Phase | 24 | 8.3 | 57.6 |

The fryer 10 provides suitable packaging/size and heavy duty output. A compact design that is meant to be used in conjunction with a refrigerator/freezer base to reduce the equipment footprint in commercial kitchens. The unit results in gaining the 30″-34″ of usable area at the bottom of the standard electric fryer cabinet and repurposing the space for use with either a standard counter or a freezer/refrigerator base.

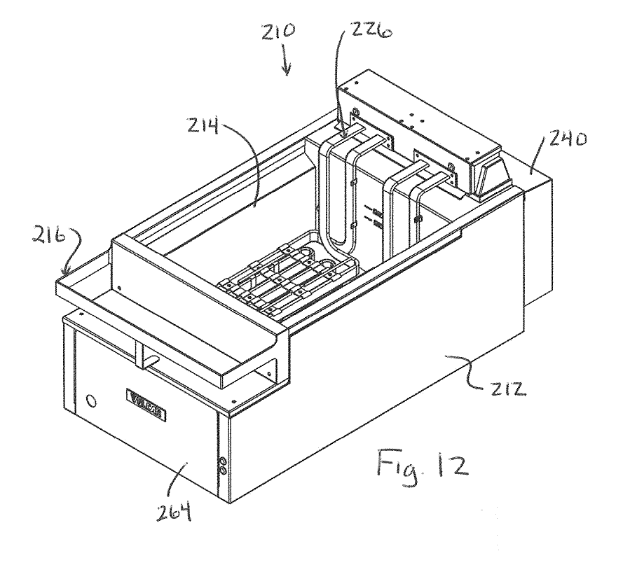

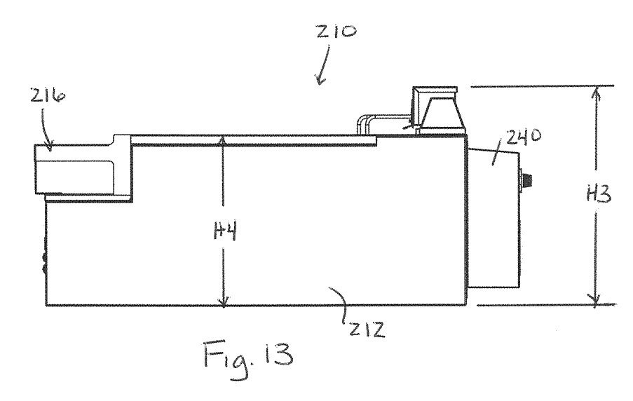

Referring now to FIGS. 12 and 13, another embodiment of a compact fryer 210 is shown and includes housing 212, fryer vat 214, condiment rack 216, heating elements 226, rear electrical cabinet 240, front door 264 for accessing a control interface (not shown). The fryer 210 includes an internal wiring raceway similar to that described above for fryer 10. Here, the total height H3 of the unit may be between 14 and 22 inches (not including any support legs), such as between 15 and 18 inches. A working height H4 of the unit may be between 12 and 15 inches. A total footprint of the fryer unit 210 is no more than 40 inches deep by 20 inches wide (e.g., footprint of 800 square inches or less). The fryer vat capacity may be between 35 and 45 pounds of oil (e.g., between 38 and 42 pounds, or about 40 pounds). The typical leg height at the underside of the unit housing (if legs are included) would be no more than about six inches (e.g., no more than about five inches, or about four inches or less). Achieved throughput for the fryer is 75 lbs/hr or more of French Fries per ASTM Test Method F1361-07 with an associated efficiency of 75%, and 35 lbs/hr or more Bone-In Chicken per ASTM Test Method F1964-11 with an efficiency of 75% of higher.

The total power of the heating system for fryer 210 may be between 15 and 20 kW (e.g., between 16 kW and 18 kW, or about 17 kW) and two heating elements 26 are used, each having three resistance wire elements therein, where the resistive wire elements are tuned to the known power source that will be used. By example, the amps per resistive wire element and ohms per resistive wire element may be in accordance with the following table:

TABLE 2
Exemplary Power Ratings

| | | AMPS PER | OHMS PER |
|---|---|---|---|
| VOLTAGE | TOTAL KW | ELEMENT | ELEMENT |
| 208/3 Phase | 17 | 13.5 | 15.5 |
| 240/3 Phase | 17 | 11.6 | 20.5 |
| 480/3 Phase | 17 | 5.8 | 82.3 |

It is to be clearly understood that the above description is intended by way of illustration and example only, is not intended to be taken by way of limitation, and that other changes and modifications are possible.

What is claimed is:

1. A fryer unit, comprising:
a housing;
a fryer vat supported by the housing and defining a volume for receiving oil to be heated for cooking;
an oil heating system including at least one immersed electrical heating unit within the fryer vat for heating oil within the fryer vat;
wherein an overall height of the fryer unit is no more than twenty-five inches so as to be adapted for positioning upon an appliance base or countertop.

2. The fryer unit of claim 1 wherein a quick-disconnect arrangement is provided for draining the fryer vat.

3. The fryer unit of claim 2 wherein the quick disconnect includes a male fitting at the outlet side of a valve that has an input side fluidly connected to the vat.

4. The fryer unit of claim 1 wherein a total power of the oil heating system is between about 15 kW and about 20 kW.

5. The fryer unit of claim 4 wherein the fryer unit has a total footprint of no more than 40 inches by 30 inches, a working height of less than 16 inches, and a fryer vat capacity of between 70 and 80 pounds of oil.

6. The fryer unit of claim 5 wherein the fryer unit has a total height, from a bottom of the housing upward, of no more than about 23 inches.

7. The fryer unit of claim 1 wherein a total power of the oil heating system is between about 23 kW and about 28 kW.

8. The fryer unit of claim 7 wherein the fryer unit has a total footprint of no more than 40 inches by 20 inches, a working height of less than 16 inches, and a fryer vat capacity of between 30 and 45 pounds of oil.

9. The fryer unit of claim 8 wherein the fryer unit has a total height, from a bottom of the housing upward, of no more than about twenty inches.

10. The fryer unit of claim 1, further comprising rack at a front side of the fryer unit as part of the housing.

11. The fryer unit of claim 1, further comprising:
an electrical cabinet at a rear side of the fryer unit and housing multiple electrical components;
a control interface at a front of the fryer unit; and
a wiring raceway within the housing for wiring that connects the control interface to the electrical cabinet.

12. The fryer unit of claim 11 wherein the wiring raceway includes an L-shaped wiring cover that is positioned along an internal bottom wall and internal sidewall of the housing so that the wiring raceway is formed by the wiring cover, a portion of the internal bottom wall and a portion the internal sidewall.

13. The fryer unit of claim 12 wherein the wiring cover is removably engaged to the housing by a set of tangs that engage with slots on the internal bottom wall.

14. The fryer unit of claim 11 wherein an internal section of the housing, running from a front of the fryer vat to a rear of the fryer vat, does not include any electrical components.

15. The fryer unit of claim 11 wherein the control interface is located behind a movable front door of the housing.

16. A fryer unit, comprising:
a housing;
a fryer vat supported by the housing and defining a volume for receiving oil to be heated for cooking;
an oil heating system including at least one immersed electrical heating unit within the fryer vat for heating oil within the fryer vat;
wherein a working height of the fryer unit is no more than sixteen inches;
wherein the housing includes a condiment rack at a front side of the fryer unit.

17. The fryer unit of claim 16 wherein the condiment rack has an open top and is formed by a bottom wall, a rear wall and a raised rail that extends along left, right and front sides of the rack.

18. The fryer unit of claim 17 wherein the condiment rack is removable from the housing as a single piece.

19. The fryer unit of claim 17 wherein a control interface of the fryer unit includes a box-shaped housing located behind a front door of the housing and below the condiment rack.
